(19) United States
(12) Patent Application Publication
(10) Pub. No.: US 2003/0188056 A1
(43) Pub. Date: Oct. 2, 2003

(54) Method and apparatus for packet reformatting

(76) Inventor: Suresh Chemudupati, Marlboro, MA (US)

Correspondence Address: Timothy N. Trop, TROP, PRUNER & HU, P.C., STE 100, 8554 KATY FWY, HOUSTON, TX, 77024-1841, US

(21) Appl. No.: 10/107,625

(22) Filed: Mar. 27, 2002

(51) Int. Cl. G06F 3/00

(52) U.S. Cl. 710/51

(57) ABSTRACT

A packet reformatter is disclosed that may store packet information received in one format and reformat the received packet information into a different format.

### BACKGROUND

This invention relates to data formatting and in particular to the reformatting of packets in a network.

To support the ever increasing needs of businesses for high speed computing, server computers have become faster and more complex. For example, it is common today for a server to include multiple microprocessors such as those provided by the Intel Corporation. In addition, the speed of those microprocessors has been increasing year by year as technology has improved and needs of businesses for faster servers has expanded.

To keep pace with the ever increasing speed of the servers, new input/output (I/O) technologies have been developed to provide for high speed interconnection with network and other devices. For example, the InfiniBand™ Architecture has been developed by Intel Corporation and other companies to provide a high capacity I/O standard that companies can design to and implement in as an industry standard. The InfiniBand™ Architecture Version 1.0.A Specifications released Jun. 19, 2001, may be obtained from the InfiniBand™ website at www.inifinibandta.org. The InfiniBand™ Architecture has become an industry standard channel switch fabric interconnection system for servers. A server utilizing an InfiniBand™ I/O system may be able to support a link rate of up to 30 Gbyts/sec which is a significant improvement over previous I/O architectures.

Additionally, with the growth of the World Wide Web, there is a need for servers to be able to support high speed Internet Protocol network services and to support high band width connectivity. To accelerate such high speed Internet Protocol systems, the Intel® Internet Exchange Architecture (Intel® IXA) standard has been developed. The standard is a packet processing architecture that provides a foundation for developing software that is portable across multiple generations of network processors. To support the IXA standard, Intel Corporation has developed an IXP 1200 Network Processor family. The IXP 1200 Network Processors can replace many application-specific integrated circuits (ASICs) found in traditional networking equipment. By being software-programmable, the IXP 1200 allows network equipment vendors to develop new products faster.

It is highly desirable to combine an IXP 1200 processor with an InfiniBand™ I/O system to achieve the benefits provided by the InfiniBand™ I/O system with the flexibility and speed of the IXP 1200 Network Processor. However, for performance reasons, the packet header format utilized by IXP 1200 Network processor may be different from that utilized by Infiniband. Therefore, what is needed is a packet reformatter that can reformat the packets between the InfiniBand™ and IXP 1200 Network Processors.

### BRIEF DESCRIPTION OF THE DRAWINGS

Features and advantages of embodiments of the claimed subject matter will become apparent as the following detailed description proceeds, and upon reference to the drawings, where in like numerals to pick like parts, and in which:

FIG. 1 is a block diagram of a computer system according to an embodiment of the invention.

FIG. 2 is a block diagram of a packet reformatter according to an embodiment of the invention.

FIG. 3 illustrates packet organization without a GRH header according to an embodiment.

FIG. 4 illustrates packet organization with a GRH header according to an embodiment of the invention.

FIG. 5 is a schematic diagram of a packet reformatter according to an embodiment of the invention.

It should be understood that although the following detailed description will proceed with reference being made to illustrative embodiments of the claimed subject matter, many alternatives, modifications, and variations thereof will be apparent to those skilled in the art. Accordingly, it is intended that the claimed subject matter be viewed broadly and be defined only as set forth in the accompanied claims.

### DETAILED DESCRIPTION

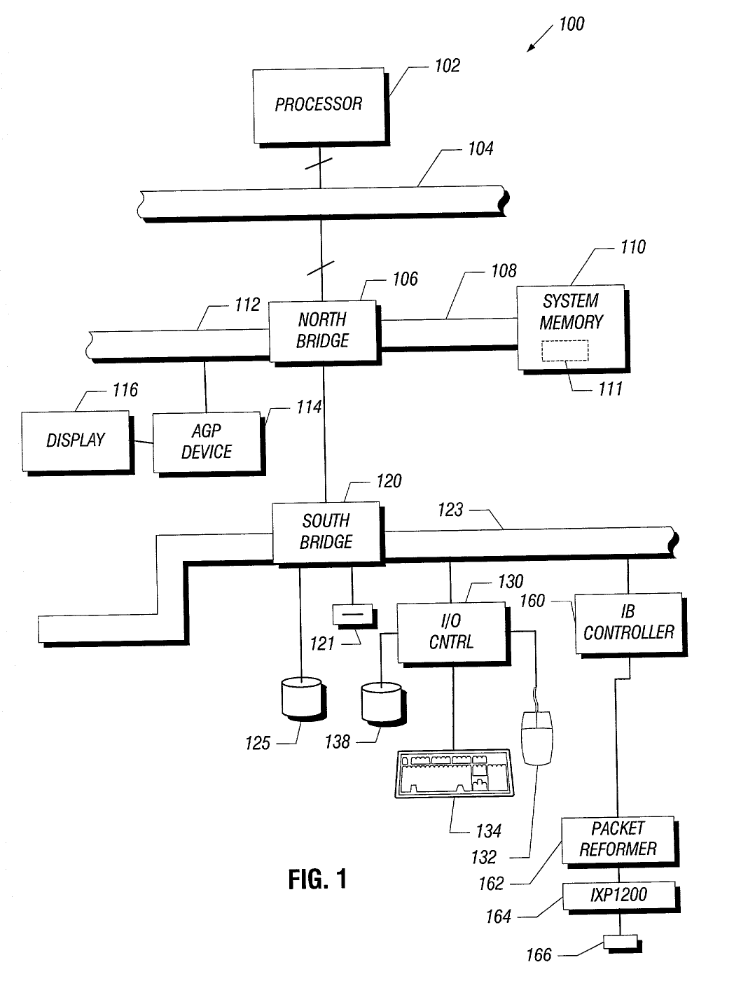

Referring to FIG. 1, a server 100 may include a processor (one or more microprocessors, for example) 102, that is coupled to a local bus 104. Also coupled to local bus 104 may be, for example, a memory hub, or north bridge 106. The north bridge 106 provides interfaces to the local bus 104, a memory bus 108, an Accelerated Graphics Port (AGP) bus 112, and a hub link. The AGP bus is described in detail in the Accelerated Graphics Port Interface Specification, revision 1.0, published Jul. 31, 1996, by Intel Corporation, Santa Clara, Calif. A system memory 110 maybe accessed via the system bus 108, and an AGP device 114 may communicate over the AGP bus 112 and generate signals to drive a display 116.

A system memory 110 may store various program instructions such as instructions for an operating system and application programs that may be utilized with the server 100. In this manner, in some embodiments of the present invention, those instructions enable the processor 102 to perform one or more techniques that are described below.

The north bridge 106 may communicate with a south bridge 110 over a hub link. In this manner, the south bridge 120 may provide an interface for the input/output (I/O) expansion bus 123 in a Peripheral Component Interconnect (PCI) bus 140. The PCI specification is available from the PCI Special Interest Group, Portland, Oreg. 97214. An I/O controller 130 maybe coupled to the I/O expansion bus 123 and may receive input from a mouse 132 and a keyboard 134 as well as control operations on a floppy disk 138. The south bridge 120 may, for example, control the operations of a hard disk drive 125 and a compact disk read only memory (CD-ROM) drive 121.

Additionally, the south bridge 120 may be coupled by the I/O expansion bus 123 to an InfiniBand™ controller 160. The InfiniBand controller 160 may in turn be coupled to a packet reformatter 162 which is in turn coupled to one or more IXP 1200 Network Processors 264. The IXP 1200 Processor 264 may in turn be coupled to a network port 266.

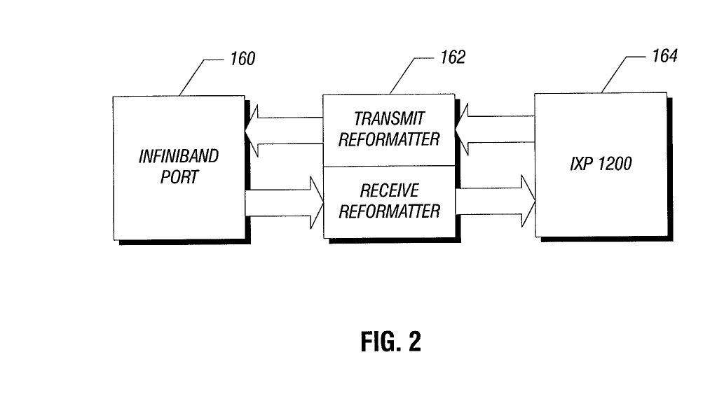

Referring now to FIG. 2, the packet reformatter 162 provides a transmit reformatter which reformats packets from the IXP 1200 164 to the InfiniBand Port 160. In addition, the packet reformatter 162 may include a receive formatter that may convert packets from the InfiniBand Port 160 to the IXP 1200 Network Processor 164. The packet reformatter 162 may receive InfiniBand (IB) packets from the IXP 1200 Network Processor in bursts of 64 byte packets called m-packets. The first m-packet contains the InfiniBand header followed by packet pay-load in subsequent m-packets. Three common IB packet headers include an LRH (local router header), BTH (base transport header), and the GRH (global routing header). A link next header field which is located in the LRH may indicate the presence, or absence, of a GRH.

The packet reformatter 162 maybe configurated to accept out of sequence IB header field packets from the IXP 1200 164. The packer reformatter 162 then may rearrange the header fields, in some embodiments, to match the IB standard sequence before sending it to the InfiniBand Port 10 160. In addition to reformatting these out of sequence header fields back to the IB format standard, unneeded padding bits which may be included in the overall packet may also be eliminated.

Table 1 illustrates the order of an LRH in accordance
with the InfiniBand standard:
LRH Definition (in IBA Standard order of appearance on the
IB fabric)

| Field Designator | Field Name | Number of Bits |
|---|---|---|
| L1 | VL | 4 |
| L2 | Link Version | 4 |
| L3 | Service Level | 4 |
| L4 | Reserved | 2 |
| L5 | Link Next Header | 2 |
| L6 | Destination LID | 16 |
| L7 | Reserved | 5 |
| L8 | Packet Length | 11 |
| L9 | Source LID | 16 |

Table 2 illustrates a GRH in accordance with the
InfiniBand Standard:
GRH Definition (in IBA Standard order of appearance on the
IB fabric)

| Field Designator | Field Name | Number of Bits |
|---|---|---|
| G1 | IP Version | 4 |
| G2 | Traffic Class | 8 |
| G3 | Flow Label | 20 |
| G4 | Payload Length | 16 |
| G5 | Next Header | 8 |
| G6 | Hop Limit | 8 |
| G7 | Source Global ID | 128 |
| G8 | Destination Global | 128 |
| | ID | |

Table 3 illustrates a BTH standard in accordance with
the InfiniBand Standard:
BTH Definition (in IBA Standard order of appearance on the
IB fabric)

| Field Designator | Field Name | Number of Bits |
|---|---|---|
| B1 | OpCode | 8 |
| B2 | Solicited Event | 1 |
| B3 | Migrate | 1 |
| B4 | Pad Count | 2 |
| B5 | Transport Header | 4 |
| | Version | |
| B6 | Partition Key | 16 |
| B7 | Reserved | 8 |
| B8 | Destination Queue | 24 |
| | Pair | |
| B9 | AckReq | 1 |
| B10 | Reserved | 7 |
| B11 | Packet Sequence | 24 |
| | Number | |

In some embodiments, the IXP 1200 may send transmit packet header information in one of two ways. The first way is without a GRH and the second way is with a GRH included in the header.

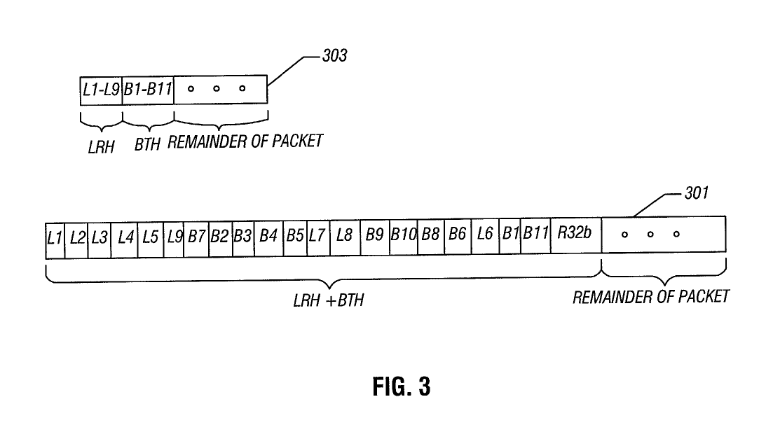

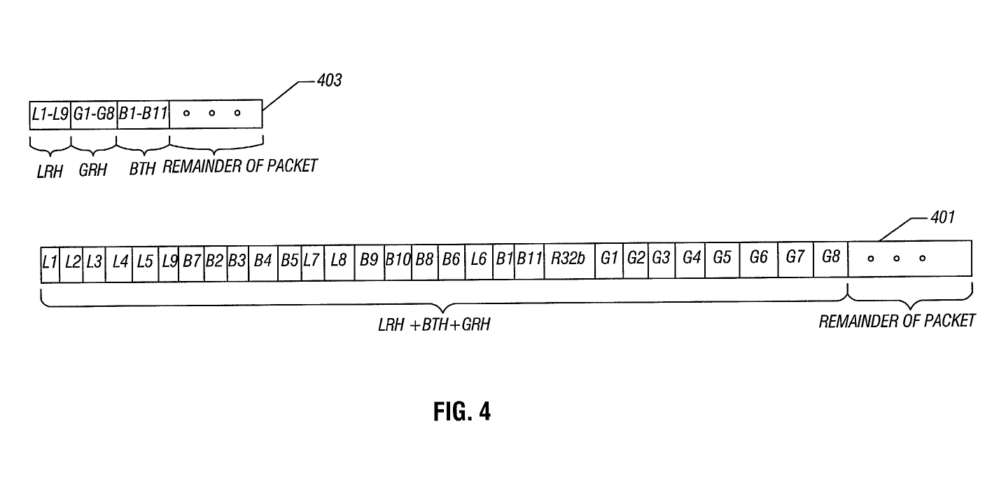

Referring to FIG. 3, the IXP 1200 164 may send a header packet without a GRH which may take the form illustrated by 301. The packet 301 may then be reformatted by the packet reformatter 162 to take the form illustrated in 303. When a GRH is included in the transmit packet header, the IXP 1200 164 may transmit a packet having the format illustrated in 401 in FIG. 4. The packet 401 may then be converted by the packet reformatter 162 into a standard InfiniBand format illustrated in 403 in FIG. 4.

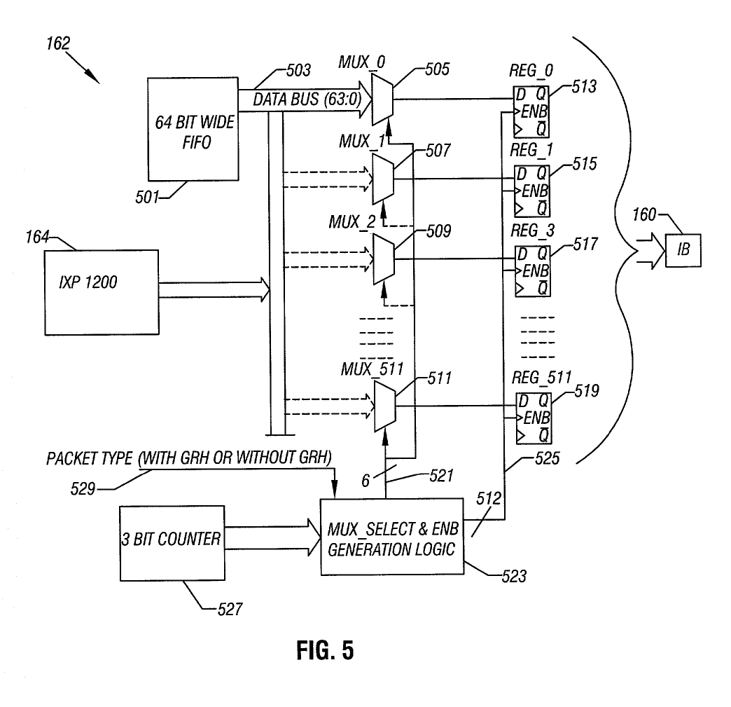

Referring now to FIG. 5, the packet reformatter 162 may include a FIFO Memory Device 501. FIFO 501, in some embodiments, may be organized as eight 64 bit words. The FIFO 501 may be coupled by data bus 503 to 512 multiplexors of which four are shown 505-511. Each of the 512 multiplexors maybe coupled to a register such as illustrated by registers 513-519.

Each of the 512 multiplexors is controlled by a multiplexor select line 521, which may be generated by a multiplexor select and enable generation logic 523. The multiplexor select and enable generation logic may be a state machine, microcontroller, or other suitable circuit. Additionally, in some embodiments, each of the 512 registers 513-519 will latch data in response to enable control lines 525 that may also be generated by the multiplexor select and enable generation logic 523.

A 3 bit counter 527 provides a count input to the multiplexor select and enable generation logic 523. Additionally, a packet select line 529 may be coupled to the multiplexor select and enable generation logic 523. The packet select line 529 in some embodiments, may be utilized to indicate to the multiplexor select and enable generation logic that the packet being received from the IXP 1200 164 includes a GRH or does not include a GRH. The packet select line signal may be generated by a circuit (not shown) monitoring the link next header field.

The IXP 1200 164 may be coupled to the FIFO 510, in some embodiments, through data bus 503. Outputs from the 512 registers 513-519 may be coupled to the InfiniBand Port 160 as required to achieve packet reformatting.

The out of sequence header bits that are coming from the IXP 1200 Network Processor 164, as illustrated in FIGS. 3 and 4, are stored in the FIFO 501. Since, in some embodiments, the FIFO is 64 bits wide, 64 bits are reformatted for each clock cycle provided by the counter 527. For each count from counter 527 the multiplexor select and enable generation logic 523 controls the 512 multiplexors 505-511 such that they select an appropriate bit that may be present on data bus 503 from the FIFO. Additionally, the multiplexor select and an enable generation logic 523 controls the 512 registers 513-519 to latch the appropriate data bits coming from the multiplexors 505-511.

The multiplexor select lines 521 are controlled based, in some embodiments, on the packet type (with out without GRH) and count value from the counter 527. Similarly, the enables for the registers 513-519 may also be based on the packet type (with out without GRH) and count value.

Therefore, based on the out of sequence bits received on each clock from the FIFO 510, the multiplexor select 521 and register enables 525 are generated so that the header packet received from the IXP 1200 and stored in FIFO 501 is appropriately reformatted into a InfiniBand format such as illustrated in FIGS. 3 and 4. Given a 512 bit packet header, the packet reformatter 162 may reformat the 512 bits of a packet header received from a IXP 1200 164 into a standard InfiniBand format header in eight clock cycles.

Of course, other modifications are possible. For example, the FIFO 501 may be organized, in some embodiments, as one word that is 512 bits wide which may enable a conversion to be done in one clock cycle. As would be understood by those skilled in the art, other permutations are also possible.

Additionally, packet reformatter 162 may be modified to reformat data that may be received from a device other than an IXP 1200 into a format that may or may not be compatible with an InfiniBand system by adjusting the various components such as the FIFO 501, multiplexors 505-511, registers 513-519, and counter 527 and multiplexor select and enable generation logic 523 as appropriate for a specific application.

While the present invention has been described with respect to a limited number of embodiments, those skilled in the art will appreciate numerous modifications and variations therefrom. It is intended that the appended claims cover all such modifications and variations as falling within the true spirit and scope of this present invention.

What is claimed is:

1. A device comprising:
a memory device having output bits;
a plurality of multiplexors coupled to the output bits and each multiplexor having an output coupled to a register of a plurality of registers wherein each register includes an output;
a control coupled to the plurality of multiplexors and registers and operative to select a particular memory device output bit for presentation at an output of a particular register.

2. The device as in claim 1 wherein the memory device stores packet header data.

3. The device as in claim 2 further comprising a network processor coupled to the memory device and the memory device is operative to store packet data from the network processor.

4. The device as in claim 3 wherein the memory device is operative to store 512 bits of packet data.

5. The device as in claim 3 wherein the control includes a counter coupled to a multiplexor select control and a register enable control.

6. The device as in claim 5 wherein the counter has an output coupled to the memory device and the memory device outputs a particular set of output bits in correspondence to a particular counter output.

7. The device as in claim 6 wherein the control is coupled to a packet type select signal and the control controls, in part, the multiplexors to select particular memory device output bits in response to the packet type select signal.

8. The device as in claim 1 wherein the outputs of the plurality of registers are coupled to a computer I/O port.

9. The device as in claim 8 wherein the outputs of the plurality of registers are coupled to an I/O port complying with the InfiniBand version 1.0.a standard.

10. A system comprising:
a processor; and
a first memory storing a program to cause the processor to:
receive a first packet in a first format;
examine header information contained in the first packet and;
based on the header information, reformat the first packet into a second packet having one of at least two different formats that are different from the first format.

11. The system of claim 10, wherein the first packet is stored in a second memory device having output bits coupled to a plurality of multiplexors and each multiplexor includes an output coupled to one of a plurality of registers wherein each register includes an output; and a control is coupled to the plurality of multiplexors and registers and selects, in part, a particular second memory device output bit for presentation at an output of a particular register.

12. The system of claim 11 wherein the second memory device stores packet header data.

13. The system of claim 12 wherein a network processor is coupled to the second memory device and the second memory device is operative to store packet data from the network processor.

14. The system of claim 13 wherein the control includes a counter coupled to a multiplexor select control and a register enable control.

15. The system of claim 14 wherein the counter has an output coupled to the second memory device and the second memory device outputs a particular set of output bits in correspondence to a particular counter output.

16. The system of claim 15 wherein the control is coupled to a packet type select signal and the control controls, in part, the multiplexors to select particular memory device output bits in response to the packet type select signal.

17. The system of claim 11 wherein the outputs of plurality of registers are coupled to a computer I/O port.

18. The system of claim 11 wherein the outputs of plurality of registers are coupled to a computer I/O port complying with the InfiniBand version 1.0.a standard.

19. A method comprising:
receiving a first packet in a first format;
examining header information contained in the first packet; and
based on the header information, reformat the first packet into a second packet having one of at least two different formats that are different from the first format.

20. The method of claim 19, further comprising storing the first packet in a second memory device having output bits coupled to a plurality of multiplexors and, utilizing the multiplexors, selecting particular output bits from the second memory, and storing the selected output bits in a plurality of bit storage devices; and transmitting the bits stored in the bit storage devices to an I/O port.

21. The method of claim 20, wherein storing the first packet includes storing packet header data in the second memory device.

22. The method of claim 19, wherein the first packet is received from a network processor.

23. The method of claim 19, wherein a packet type select signal is utilized to determine, in part, the second packet format.
